(19) United States
(12) Patent Application Publication
(10) Pub. No.: US 2019/0212524 A1
(43) Pub. Date: Jul. 11, 2019

(54) IMAGING LENS

(71) Applicant: KANTATSU CO., LTD., Yaita-shi (JP)

(72) Inventor: Hisao FUKAYA, Sukagawa-city (JP)

(21) Appl. No.: 16/059,543

(22) Filed: Aug. 9, 2018

(30) Foreign Application Priority Data
Aug. 10, 2017 (JP) 2017-155052

(51) Int. Cl. G02B 9/60; H04N 5/225; G02B 7/02

(52) U.S. Cl. CPC G02B 9/60; G02B 7/021; H04N 5/2254

(57) ABSTRACT

There is provided an imaging lens with high resolution which satisfies in well balance low-profileness and low F-number and properly corrects aberrations.

An imaging lens comprise in order from an object side to an image side, a first lens, a second lens having a convex surface facing the object side near an optical axis, a third lens having negative refractive power and the convex surface facing the object side near the optical axis, a fourth lens, and a fifth lens, wherein below conditional expressions (1) and (2) are satisfied:

0.4<TTL/f<1.0 (1)

0.4<f/TTL<1.7 (2)

where
TTL: total track length,
f: focal length of an overall optical system, and
f5: focal length of the fifth lens.

The present application is based on and claims priority of a Japanese patent application No. 2017-155052 filed on Aug. 10, 2018, the entire contents of which are hereby incorporated by reference.

### BACKGROUND OF THE INVENTION

### Field of the Invention

The present invention relates to an imaging lens which forms an image of an object on a solid-state image sensor such as a CCD sensor or a C-MOS sensor used in an imaging device, and more particularly to an imaging lens which is built in an imaging device mounted in an increasingly compact and high-performance smartphone and mobile phone, an information terminal such as a PDA (Personal Digital Assistant), a game console, PC and a robot, and moreover, a home appliance, a monitoring camera and an automobile with camera function.

### Description of the Related Art

In recent years, it becomes common that camera function is mounted in a home appliance, information terminal equipment, an automobile and public transportation. Demand of products with the camera function is more increased, and development of products is being made accordingly.

The imaging lens mounted in such equipment is required to be compact and have high-resolution performance, and moreover, is required to be widespread and low in cost.

As a conventional imaging lens aiming high performance, for example, the imaging lens disclosed in Patent Document 1 (JP Patent No. 5607264) has been known.

Patent Document 1 discloses an imaging lens comprising, in order from an object side, a first lens of a meniscus shape having a convex surface facing the object side and negative refractive power, a second lens having the convex surface facing the object side and positive refractive power, a third lens of the meniscus shape having the convex surface facing an image side and positive refractive power, a fourth lens having a concave facing the object side and the negative refractive power, and a fifth lens having the convex surface facing the object side and the positive refractive power.

### SUMMARY OF THE INVENTION

However, in lens configurations disclosed in the above-described Patent Document 1, when low F-number is to be realized, it is very difficult to correct aberrations at a peripheral area, and excellent optical performance is obtained.

The present invention has been made in view of the above-described problems, and an object of the present invention is to provide an imaging lens with high resolution which satisfies in well balance low-profileness and the low F-number and excellently corrects aberrations.

Regarding terms used in the present invention, a convex surface, a concave surface or a plane surface of lens surfaces implies that a shape of the lens surface near an optical axis (paraxial portion), and refractive power implies the refractive power near the optical axis. The pole point implies an off-axial point on an aspheric surface at which a tangential plane intersects the optical axis perpendicularly. The total track length is defined as a distance along the optical axis from an object-side surface of an optical element located closest to the object to an image plane, when thickness of an IR cut filter or a cover glass which may be arranged between the imaging lens and the image plane is regarded as an air.

An imaging lens according to the present invention forms an image of an object on a solid-state image sensor, and comprises in order from an object side to an image side, a first lens, a second lens having a convex surface facing the object side near an optical axis, a third lens having negative refractive power and the convex surface facing the object side near the optical axis, a fourth lens, and a fifth lens.

The imaging lens according to the above-described configuration achieves the low-profileness by strengthening the refractive power of the first lens. The second lens properly corrects spherical aberration and astigmatism by having the convex surface facing the object side near the optical axis. The third lens properly corrects chromatic aberration, coma aberration and field curvature by having the convex surface facing the object side near the optical axis and the negative refractive power. The fourth lens and the fifth lens correct aberrations of the astigmatism, the field curvature and the distortion in well balance while maintaining the low-profileness.

According to the imaging lens having the above-described configuration, it is preferable that a below conditional expression (1) is satisfied:

0.4<TTL/f<1.0 (1)

where
TTL: total track length, and
f: focal length of an overall optical system.

The conditional expression (1) defines the total track length to the focal length of an overall optical system, and is a condition for achieving low-profileness and proper aberration corrections. When a value is below the upper limit of the conditional expression (1), the total track length is shortened and the low-profileness is easily achieved. On the other hand, when the value is above the lower limit of the conditional expression (1), the spherical aberration and the chromatic aberration are properly corrected.

According to the imaging lens having the above-described configuration, it is preferable that the refractive power of the fifth lens is positive, and moreover, a below conditional expression (2) is satisfied:

0.4<f5/TTL<1.7 (2)

where
f5: focal length of the fifth lens, and
TTL: total track length.

The fifth lens more facilitates the low-profileness by having the positive refractive power. Furthermore, diffusion of marginal ray incident to the image sensor is suppressed, a lens diameter of the fifth lens becomes small and reducing diameter of the imaging lens is achieved. The conditional expression (2) defines the refractive power of the fifth lens, and is a condition for achieving the low-profileness and proper aberration corrections. When a value is below the upper limit of the conditional expression (2), the refractive power of the fifth lens becomes appropriate and the low-profileness is achieved. On the other hand, when the value is above the lower limit of the conditional expression (2), the chromatic aberration and the astigmatism are properly corrected.

According to the imaging lens having the above-described configuration, it is preferable that an image-side surface of the first lens is the concave surface facing the image side near the optical axis.

When the image-side surface of the first lens is the concave surface facing the image side near the optical axis, the spherical aberration and the coma aberration are properly corrected.

According to the imaging lens having the above-described configuration, it is preferable that the second lens has a meniscus shape having the convex surface facing the object side near the optical axis.

When the second lens has a meniscus shape having the convex surface facing the object side near the optical axis, axial chromatic aberration, and high-order spherical aberration, coma aberration and field curvature are properly corrected.

According to the imaging lens having the above-described configuration, it is preferable that the image-side surface of the fourth lens is the concave surface facing the image side near the optical axis. Furthermore, it is more preferable that the image-side surface of the fourth lens is an aspheric surface having an off-axial pole point.

When the image-side surface of the fourth lens is the concave surface facing the image side near the optical axis, the field curvature and the distortion are properly corrected. Furthermore, when the image-side surface of the fourth lens has the off-axial pole point, the field curvature and the distortion are properly corrected.

According to the imaging lens having the above-described configuration, it is preferable that the image-side surface of the fifth lens is the convex surface facing the image side near the optical axis.

When the image-side surface of the fifth lens is the convex surface facing the image side near the optical axis, the light ray incident to the image-side surface of the fifth lens is appropriately controlled and the chromatic aberration and the spherical aberration are properly corrected.

According to the imaging lens having the above-described configuration, it is preferable that the first lens, the second lens, the third lens, the fourth lens and the fifth lens have at least one aspheric surface, respectively.

When each lens has at least one aspheric surface, the aberrations are properly corrected.

According to the imaging lens having the above-described configuration, it is preferable that a below conditional expression (3) is satisfied:

0.2<f1/f<0.7 (3)

where
f1: focal length of the first lens, and
f: focal length of the overall optical system.

When the first lens has the positive refractive power, the low-profileness is more facilitated. The conditional expression (3) defines the refractive power of the first lens, and is a condition for achieving the low-profileness and the proper aberration corrections. When a value is below the upper limit of the conditional expression (3), the positive refractive power of the first lens becomes appropriate and the low-profileness is achieved. On the other hand, when the value is above the lower limit of the conditional expression (3), the spherical aberration and the coma aberration are properly corrected.

According to the imaging lens having the above-described configuration, it is preferable that the refractive power of the second lens is negative, and moreover, a below conditional expression (4) is satisfied:

−1.35<f2/f<−0.40 (4)

where
f2: focal length of the second lens, and
f: focal length of the overall optical system of the imaging lens.

When the second lens has the negative refractive power, correction of the spherical aberration and the chromatic aberration is more facilitated. The conditional expression (4) defines the refractive power of the second lens, and is a condition for achieving the low-profileness and the proper aberration corrections. When a value is below the upper limit of the conditional expression (4), the negative refractive power of the second lens becomes appropriate and the low-profileness is achieved. On the other hand, when the value is above the lower limit of the conditional expression (4), the field curvature is properly corrected.

According to the imaging lens having the above-described configuration, it is preferable that the refractive power of the fourth lens is negative, and moreover, a below conditional expression (5) is satisfied:

−1.0<f4/f<−0.3 (5)

where
f4: focal length of the third lens, and
f: focal length of the overall optical system of the imaging lens.

When the fourth lens has the negative refractive power, correction of the chromatic aberration is more facilitated. The conditional expression (5) defines the refractive power of the fourth lens, and is a condition for achieving the low-profileness and the proper aberration corrections. When a value is below the upper limit of the conditional expression (5), the negative refractive power of the fourth lens becomes appropriate and the low-profileness is achieved. On the other hand, when the value is above the lower limit of the conditional expression (5), the field curvature and the distortion are properly corrected.

According to the imaging lens having the above-described configuration, it is preferable that a below conditional expression (6) is satisfied:

0.65<vd1/(vd2+vd3)<2.10 (6)

where
vd1: abbe number at d-ray of the first lens,
vd2: abbe number at d-ray of the second lens, and
vd3: abbe number at d-ray of the third lens.

The conditional expression (6) defines relationship between the abbe numbers at d-ray of the first lens, the second lens and the third lens, and is a condition for properly correcting aberrations. By satisfying the conditional expression (6), the axial chromatic aberration is properly corrected.

According to the imaging lens of the above-described configuration, it is preferable that a below conditional expression (7) is satisfied:

1.35<vd4/vd5<4.15 (7)

where
vd4: abbe number at d-ray of the fourth lens, and
vd5: abbe number at d-ray of the fifth lens.

The conditional expression (7) defines relationship between the abbe numbers at d-ray of the fourth lens and the fifth lens, and is a condition for properly correcting aberrations. By satisfying the conditional expression (7), the chromatic aberration of magnification is properly corrected.

According to the imaging lens having the above-described configuration, it is preferable that a below conditional expression (8) is satisfied:

0.15<D1/ΣD<0.60 (8)

where
D1: thickness along the optical axis of the first lens, and
ΣD: total sum of the thickness along the optical axis of the first lens, the second lens, the third lens, the fourth lens and the fifth lens.

The conditional expression (8) defines the thickness along the optical axis of the first lens to the total sum of the each thickness along the optical axis of the first lens to the fifth lens, and is a condition for improving formability. By satisfying the conditional expression (8), the thickness of the first lens becomes appropriate and uneven thickness of a center area and a peripheral area of the first lens becomes small. As a result, the formability of the first lens is improved.

According to the imaging lens having the above-described configuration, it is preferable that a below conditional expression (9) is satisfied:

−0.40<r7/r8<−0.05 (9)

where
r7: paraxial curvature radius of the object-side surface of the fourth lens, and
r8: paraxial curvature radius of the image-side surface of the fourth lens.

The conditional expression (9) defines relationship between paraxial curvature radii of the object-side surface and the image-side surface of the fourth lens, and is a condition for properly correcting the aberrations and for reducing sensitivity to manufacturing error of the fourth lens. By satisfying the conditional expression (9), the refractive power of the object-side surface and the image-side surface is suppressed from being excessive, and the proper correction of the aberration is achieved. Furthermore, reduction of the sensitivity to manufacturing error of the fourth lens is also is facilitated.

According to the imaging lens having the above-described configuration, it is preferable that a below conditional expression (10) is satisfied:

−19.0<|r9|/r10<−1.6 (10)

where
r9: paraxial curvature radius of the object-side surface of the fifth lens, and
r10: paraxial curvature radius of the image-side surface of the fifth lens.

The conditional expression (10) defines relationship between paraxial curvature radii of the object-side surface and the image-side surface of the fifth lens, and is a condition for achieving the low-profileness and the proper aberration corrections and reducing the sensitivity to manufacturing error. When a value is below the upper limit of the conditional expression (10), it is facilitated to suppress the spherical aberration occurred at this surface and to reduce the sensitivity to manufacturing error while maintaining the refractive power of the image-side surface of the fifth lens. On the other hand, when the value is above the lower limit of the conditional expression (10), the low-profileness is achieved while maintaining the refractive power of the fifth lens.

According to the imaging lens having the above-described configuration, it is preferable that a below conditional expression (11) is satisfied:

0.09<T2/TTL<0.35 (11)

where
T2: distance along the optical axis from the image-side surface of the second lens to the object-side surface of the third lens, and
TTL: total track length.

The conditional expression (11) defines the distance along the optical axis from the image-side surface of the second lens to the object-side surface of the third lens, and is a condition for achieving the low-profileness and the proper aberration corrections. By satisfying the conditional expression (11), the low-profileness is achieved, and the coma aberration, the field curvature and the distortion are properly corrected.

According to the imaging lens having the above-described configuration, it is preferable that a below conditional expression (12) is satisfied:

0.5<T2/T3<2.4 (12)

where
T2: distance along the optical axis from the image-side surface of the second lens to the object-side surface of the third lens, and
T3: distance along the optical axis from the image-side surface of the third lens to the object-side surface of the fourth lens.

The conditional expression (12) defines a ratio of an interval between the second lens and the third lens, and an interval between the third lens and the fourth lens, and is a condition for achieving the low-profileness and the proper aberration corrections. By satisfying the conditional expression (12), difference between the interval of the second lens and the third lens and the interval of the third lens and the fourth lens is suppressed from being increased, and the low-profileness is achieved. Furthermore, by satisfying the conditional expression (12), the third lens is arranged at an optimum position, and aberration correction function of the lens becomes more effective.

According to the imaging lens having the above-described configuration, it is preferable that a below conditional expression (13) is satisfied:

0.3<(EPsd×TTL)/(ih×f)<1.0 (13)

where
EPsd: entrance pupil radius,
TTL: total track length,
Ih: maximum image height, and
f: focal length of an overall optical system.

The conditional expression (13) defines brightness of the imaging lens. By satisfying the conditional expression (13), reduction of the marginal ray is suppressed, an image having enough brightness from the center area to the peripheral area of the image is obtained while reducing telephoto ratio (a ratio of the total track length to the focal length).

According to the imaging lens having the above-described configuration, it is preferable that a below conditional expression (14) is satisfied:

−3.70<f3/f<−0.75 (14)

where
f3: focal length of the third lens, and
f: focal length of the overall optical system.

The conditional expression (14) defines the refractive power of the third lens, and is a condition for achieving the low-profileness and the proper aberration corrections. When a value is below the upper limit of the conditional expression (14), the negative refractive power of the third lens becomes appropriate and the low-profileness is achieved. On the other hand, when the value is above the lower limit of the conditional expression (14), the field curvature and the chromatic aberration are properly corrected.

According to the imaging lens having the above-described configuration, it is preferable that composite refractive power of the fourth lens and the fifth lens is negative, and moreover, a below conditional expression (15) is satisfied:

−7.8<f45/f<−1.3 (15)

where
f45: composite focal length of the fourth lens and the fifth lens, and
f: focal length of the overall optical system of the imaging lens.

When the composite refractive power of the fourth lens and the fifth lens is negative, the chromatic aberration is easily corrected. The conditional expression (15) defines the composite refractive power of the fourth lens and the fifth lens, and a condition for achieving the low-profileness and the proper aberration corrections. When a value is below the upper limit of the conditional expression (15), the negative composite refractive power of the fourth lens and the fifth lens becomes appropriate, and correction of the spherical aberration and the astigmatism becomes facilitated. Furthermore, the low-profileness can be also achieved. On the other hand, when the value is above the lower limit of the conditional expression (15), the field curvature and the field curvature are properly corrected.

According to the imaging lens having the above-described configuration, it is preferable that a below conditional expression (16) is satisfied:

0.35<Σ(L1F−L5R)/f<1.10 (16)

where
Σ(L1F−L5R): distance along the optical axis from the object-side surface of the first lens to the image-side surface of the fifth lens, and
f: focal length of the overall optical system of the imaging lens.

The conditional expression (16) defines the distance along the optical axis from the object-side surface of the first lens to the image-side surface of the fifth lens to the focal length of the overall optical system of the imaging lens, and is a condition for achieving the low-profileness and proper aberration corrections. When a value is below the upper limit of the conditional expression (16), the low-profileness is achieved. Furthermore, back focus is secured and space for arranging a filter is also secured. On the other hand, when the value is above the lower limit of the conditional expression (16), thickness of each lens which is component of the imaging lens is easily secured. Furthermore, each interval of lenses can be appropriately determined, and the freedom in the aspheric surface is improved. Therefore, the proper aberration corrections are facilitated.

### Effect of Invention

According to the present invention, there can be provided an imaging lens with high resolution which satisfies in well balance the low-profileness and the low F-number, and properly corrects aberrations.

### BRIEF DESCRIPTION OF THE DRAWINGS

FIG. 1 is a schematic view showing a general configuration of an imaging lens in Example 1 according to the present invention;

FIG. 2 shows spherical aberration, astigmatism, and distortion of the imaging lens in Example 1 according to the present invention;

FIG. 3 is a schematic view showing the general configuration of an imaging lens in Example 2 according to the present invention;

FIG. 4 shows spherical aberration, astigmatism, and distortion of the imaging lens in Example 2 according to the present invention;

FIG. 5 is a schematic view showing the general configuration of an imaging lens in Example 3 according to the present invention;

FIG. 6 shows spherical aberration, astigmatism, and distortion of the imaging lens in Example 3 according to the present invention;

FIG. 7 is a schematic view showing the general configuration of an imaging lens in Example 4 according to the present invention;

FIG. 8 shows spherical aberration, astigmatism, and distortion of the imaging lens in Example 4 according to the present invention.

### DETAILED DESCRIPTION OF THE PREFERRED EMBODIMENT

Hereinafter, the preferred embodiment of the present invention will be described in detail referring to the accompanying drawings.

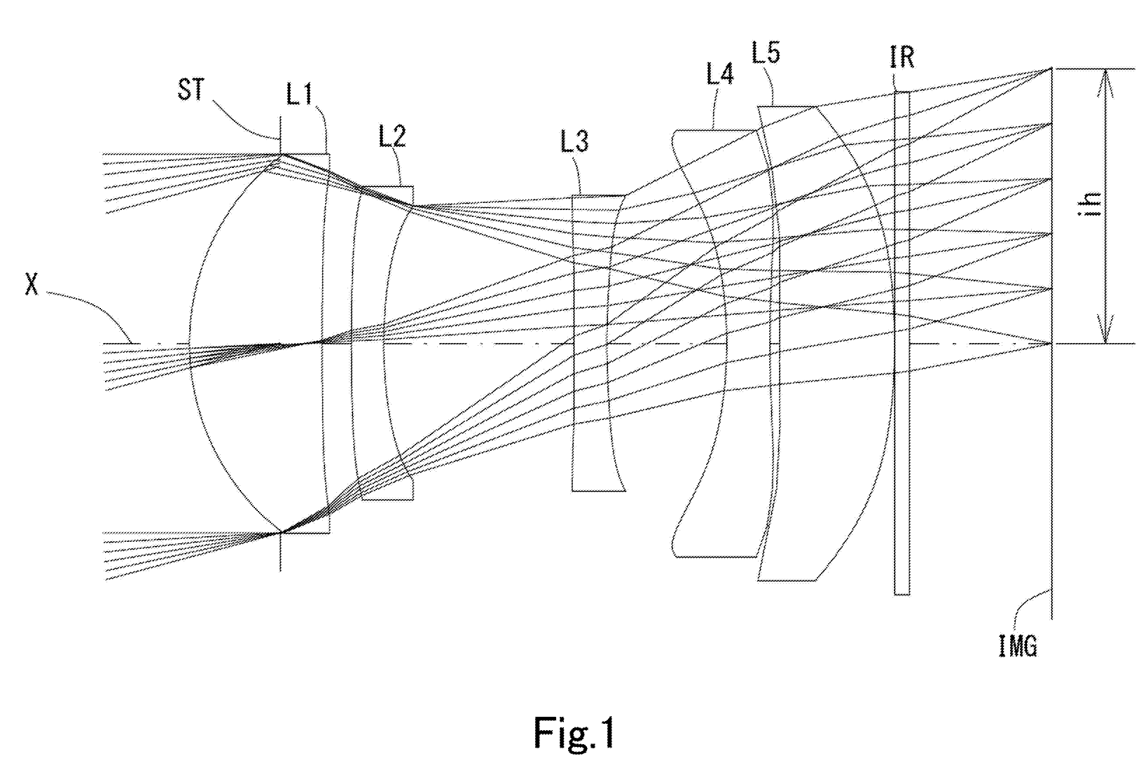

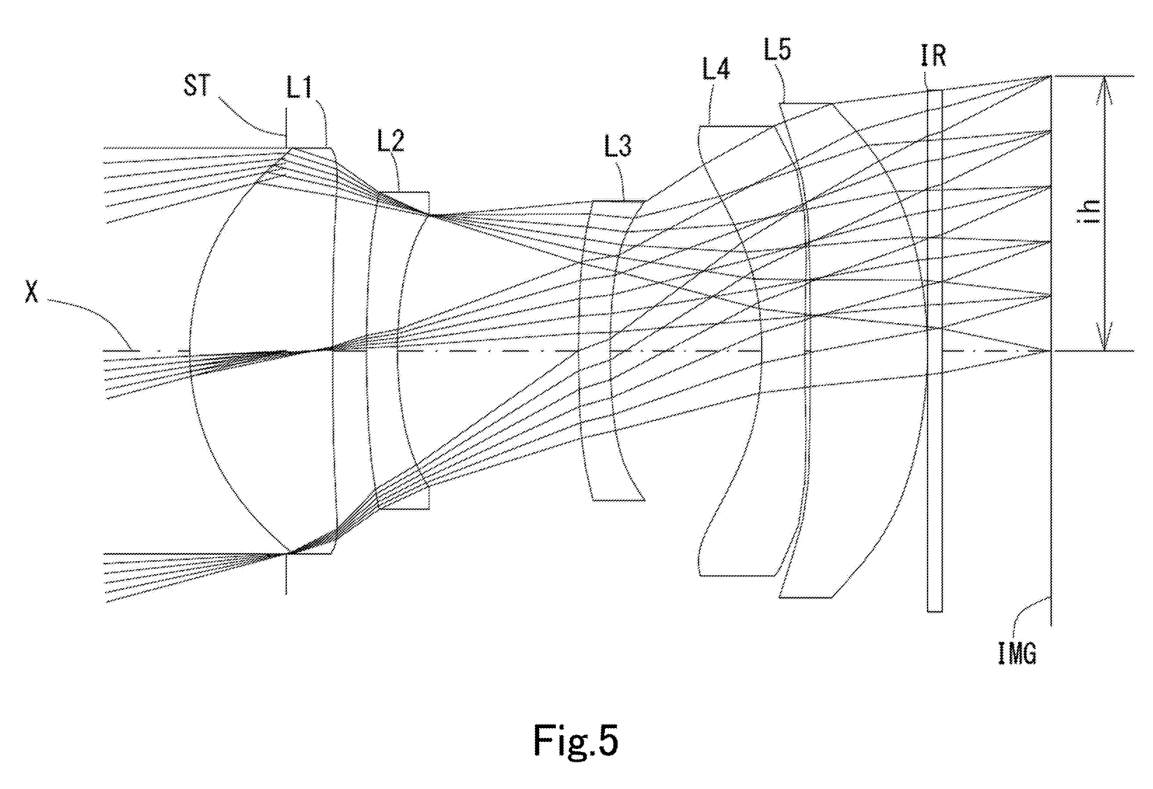

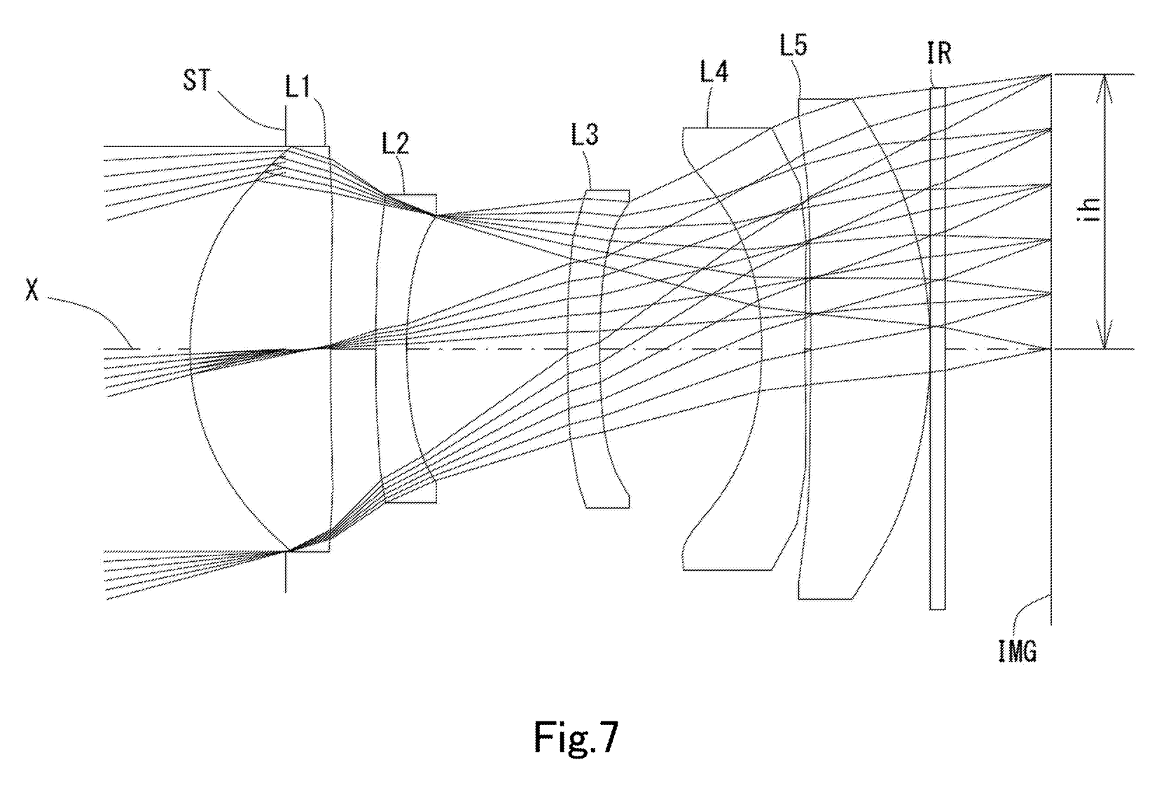

FIGS. 1, 3, 5 and 7 are schematic views of the imaging lenses in Examples 1 to 4 according to the embodiments of the present invention, respectively.

As shown in FIG. 1, the imaging lens according to the present embodiments comprises in order from an object side to an image side, a first lens L1, a second lens L2 having a convex surface facing the object side near an optical axis X, a third lens L3 having negative refractive power and the convex surface facing the object side near the optical axis X, a fourth lens, and a fifth lens.

A filter IR such as an IR cut filter and a cover glass are arranged between the fifth lens L5 and an image plane IMG (namely, an image plane of an image sensor). The filter IR is omissible.

The aperture stop ST is arranged in front of the first lens, and the correction of the aberrations and control of the light ray incident angle of high image height to the image sensor become facilitated.

The first lens L1 has the positive refractive power, and the low-profileness is achieved by strengthening the positive refractive power. The shape of the first lens L1 is a meniscus shape having the concave surface facing the image side near the optical axis X, and the coma aberration, the field curvature and the distortion are properly corrected.

The second lens L2 has the negative refractive power, and suppresses the light ray incident angle to the third lens L3 to be small and properly corrects aberration balance between a center and a peripheral area. The shape of the second lens L2 is the meniscus shape having the convex surface facing the object side near the optical axis X, and the axial chromatic aberration, and high-order spherical aberration, coma aberration and field curvature are properly corrected.

The third lens L3 has the negative refractive power, and properly corrects the field curvature and the chromatic aberration. The shape of the third lens L3 is the meniscus shape having the convex surface facing the object side near the optical axis X, and the spherical aberration, the coma aberration and the field curvature are properly corrected.

The fourth lens L4 has the negative refractive power, and properly corrects the field curvature and the distortion. The shape of the fourth lens L4 is the meniscus shape having biconcave surfaces facing the object side and the image side near the optical axis X, and the chromatic aberration is properly corrected.

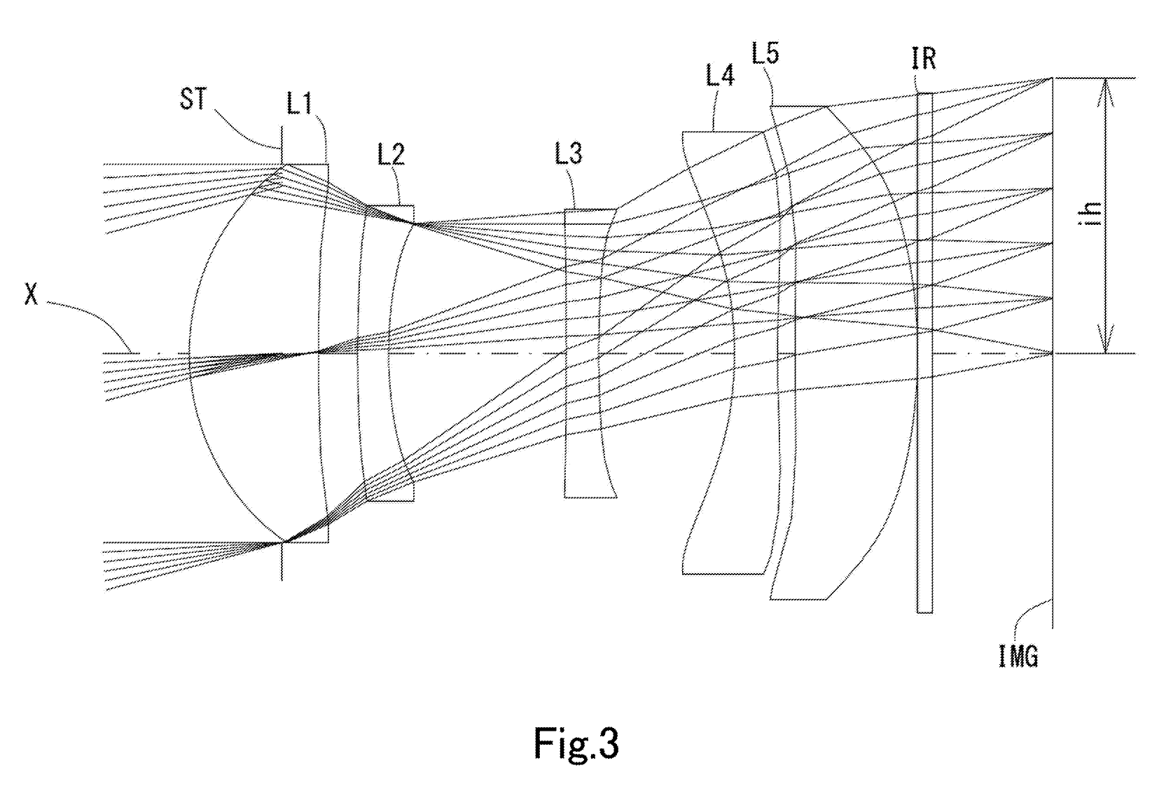

The fifth lens L5 has the positive refractive power, and the astigmatism and the field curvature are properly corrected. When the fifth lens L5 has the positive refractive power, diffusion of marginal ray incident to the image sensor is suppressed, a lens diameter of the fifth lens L5 becomes small and reducing diameter of the imaging lens is achieved. The shape of the fifth lens L5 is biconvex shape having convex surfaces facing the object side and the image side near the optical axis X, and the low-profileness is achieved. The shape of the fifth lens L5 may be the meniscus shape having the convex surface facing the image side near the optical axis X as in the Examples 2, 3 and 4 shown in FIGS. 3, 5 and 7. In this case, the light ray incident angle to the fifth lens L5 is appropriately suppressed, and the chromatic aberration and the spherical aberration are more properly corrected.

Regarding the imaging lens according to the present embodiments, for example as shown in FIG. 1, all lenses of the first lens L1 to the fifth lens L5 are preferably single lenses which are not cemented each other. Configuration without the cemented lens can frequently use the aspheric surfaces, and proper correction of the aberrations can be realized. Furthermore, workload for cementing is reduced, and manufacturing in low cost becomes possible.

Regarding the imaging lens according to the present embodiments, a plastic material is used for all of the lenses, and manufacturing is facilitated and mass production in a low cost can be realized. Both-side surfaces of all lenses are appropriate aspheric, and the aberrations are favorably corrected.

The material applied to the lens is not limited to the plastic material. By using glass material, further high performance may be aimed. All of surfaces of lenses are preferably formed as aspheric surfaces, however, spherical surfaces may be adopted which is easy to manufacture in accordance with required performance.

The imaging lens according to the present embodiments shows preferable effect by satisfying the below conditional expressions (1) to (16).

0.4<TTL/f<1.0 (1)

0.4<f5/TTL<1.7 (2)

0.2<f1/f<b 0.7 (3)

−1.35<f2/f<−0.40 (4)

−1.0<f4/f<−0.3 (5)

0.65<vd1/(vd2+vd3)<2.10 (6)

1.35<vd4/vd5<4.15 (7)

0.15<D1/ΣD<0.60 (8)

−0.40<r7/r8<−0.05 (9)

−19.0<|r9|/r10<−1.6 (10)

0.09<T2/TTL<0.35 (11)

0.5<T2/T3<2.4 (12)

0.3<(EPsd×TTL)/(ih×f)<1.0 (13)

−3.70<f3/f<−0.75 (14)

−7.8<f45/f<−1.3 (15)

0.35<Σ(L1F−L5R)/f<1.10 (16)

where
vd1: abbe number at d-ray of the first lens L1,
vd2: abbe number at d-ray of the second lens L2,
vd3: abbe number at d-ray of the third lens L3,
vd4: abbe number at d-ray of the fourth lens L4,
vd5: abbe number at d-ray of the fifth lens L5,
T2: distance along the optical axis X from the image-side surface of the second lens L2 to the object-side surface of the third lens L3,
T3: distance along the optical axis X from the image-side surface of the third lens L3 to the object-side surface of the fourth lens L4,
D1: thickness along the optical axis X of the first lens L1,
EPsd: entrance pupil radius,
ih: maximum image height,
ΣD: total sum of the thickness along the optical axis X of the first lens L1, the second lens L2, the third lens L3, the fourth lens L4 and the fifth lens L5,
Σ(L1F−L5R): distance along the optical axis X from the object-side surface of the first lens L1 to the image-side surface of the fifth lens L5,
TTL: total track length,
f: focal length of an overall optical system,
f1: focal length of the first lens L1,
f2: focal length of the second lens L2,
f3: focal length of the third lens L3,
f4: focal length of the third lens L4,
f5: focal length of the fifth lens L5,
f45: composite focal length of the fourth lens L4 and the fifth lens L5,
r7: paraxial curvature radius of the object-side surface of the fourth lens L4,
r8: paraxial curvature radius of the image-side surface of the fourth lens L4,
r9: paraxial curvature radius of the object-side surface of the fifth lens L5, and
r10: paraxial curvature radius of the image-side surface of the fifth lens L5.

It is not necessary to satisfy the above all conditional expressions, and by satisfying the conditional expression individually, operational advantage corresponding to each conditional expression can be obtained.

The imaging lens according to the present embodiments shows further preferable effect by satisfying the below conditional expressions (1a) to (16a).

0.6<TTL/f<1.0 (1a)

0.7<f5/TTL<1.40 (2a)

0.3<f1/f<0.6 (3a)

−1.10<f2/f<−0.60 (4a)

−0.8<f4/f<−0.4 (5a)

1.00<vd1/(vd2+vd3)<1.75 (6a)

2.00<vd4/vd5<3.45 (7a)

0.25<D1/ΣD<0.50 (8a)

−0.35<r7/r8<−0.10 (9a)

−16.0<|r9 |/r10<−2.4 (10a)

0.14<T2/TTL<0.28 (11a)

0.7<T2/T3<2.0 (12a)

0.45<(EPsd×TTL)/(ih×f)<0.85 (13a)

−3.10<f3/f<−1.15 (14a)

−6.5<f45/f<−2.0 (15a)

0.5<Σ(L1F−L5R)/f<0.95 (16a)

The signs in the above conditional expressions have the same meanings as those in the paragraph before the preceding paragraph.

In this embodiment, the aspheric shapes of the surfaces of the aspheric lens are expressed by Equation 1, where Z denotes an axis in the optical axis direction, H denotes a height perpendicular to the optical axis, R denotes a curvature radius, k denotes a conic constant, and A4, A6, A8, A10, A12, A14, A16, A18 and A20 denote aspheric surface coefficients.

$$Z = \frac{\frac{{H}^{2}}{R}}{1 + \sqrt{1 - ( k + 1 ) \frac{{H}^{2}}{{R}^{2}}}} + {A}_{4} {H}^{4} + {A}_{6} {H}^{6} + {A}_{8} {H}^{8} + {A}_{10} {H}^{10} + {A}_{12} {H}^{12} + {A}_{14} {H}^{14} + {A}_{16} {H}^{16} + {A}_{18} {H}^{18} + {A}_{20} {H}^{20} \qquad Equation 1$$

Next, examples of the imaging lens according to this embodiment will be explained. In each example, f denotes the focal length of the overall optical system of the imaging lens, Fno denotes an F-number, ω denotes a half field of view, and ih denotes a maximum image height. Additionally, i denotes surface number counted from the object side, r denotes a curvature radius, d denotes the distance of lenses along the optical axis (surface distance), Nd denotes a refractive index at d-ray (reference wavelength), and vd denotes an abbe number at d-ray. As for aspheric surfaces, an asterisk (*) is added after surface number i.

### EXAMPLE 1

The basic lens data is shown below in Table 1.

TABLE 1
Example 1
Unit mm

| | |
|---|---|
| f = 7.43 | ih = 2.04 |
| Fno = 2.6 | TTL = 6.36 |
| ω (°) = 15.1 | |

Surface Data

| Surface | Curvature | Surface | Refractive | Abbe |
|---|---|---|---|---|
| Number i | Radius r | Distance d | Index Nd | Number vd |
| (object) | Infinity | Infinity | | |
| 1 (Stop) | Infinity | −0.6717 | | |
| 2* | 1.7726 | 0.9847 | 1.544 | 55.86 (vd1) |
| 3* | 55.5990 | 0.2167 | | |
| 4* | 18.8354 | 0.2400 | 1.661 | 20.37 (vd2) |
| 5* | 3.4841 | 1.4102 | | |
| 6* | 23.0630 | 0.2450 | 1.661 | 20.37 (vd3) |
| 7* | 5.7406 | 0.8882 | | |
| 8* | −3.3118 | 0.3200 | 1.544 | 55.86 (vd4) |
| 9* | 12.0313 | 0.0700 | | |
| 10* | 21.3353 | 0.8543 | 1.661 | 20.37 (vd5) |
| 11* | −5.8085 | 0.2000 | | |
| 12 | Infinity | 0.1100 | 1.517 | 64.17 |
| 13 | Infinity | 0.8601 | | |
| Image Plane | Infinity | | | |

Constituent Lens Data

| Lens | Start Surface | Focal Length | Composite | Focal Length | entrance | pupil radius |
|---|---|---|---|---|---|---|
| 1 | 2 | 3.342 | f45 | −20.455 | EPsd | 1.428 |
| 2 | 4 | −6.510 | | | | |
| 3 | 6 | −11.633 | | | | |
| 4 | 8 | −4.736 | | | | |
| 5 | 10 | 6.997 | | | | |

Aspheric Surface Data

| | Second Surface | Third Surface | Fourth Surface | Fifth Surface | Sixth Surface | Seventh Surface |
|---|---|---|---|---|---|---|
| k | 0.000000E+00 | 0.000000E+00 | 0.000000E+00 | 0.000000E+00 | 0.000000E+00 | 0.000000E+00 |
| A4 | −1.667073E−03 | 1.023573E−02 | −2.125560E−03 | 4.265960E−03 | −9.751523E−02 | −7.650550E−02 |
| A6 | 2.728168E−03 | 1.959429E−03 | 3.985254E−02 | 7.586364E−02 | 6.256016E−02 | 9.071770E−02 |
| A8 | −2.508759E−03 | 1.060216E−04 | −3.944113E−02 | −7.484582E−02 | 3.869074E−02 | −1.667955E−02 |
| A10 | 1.086557E−03 | 1.601560E−03 | 4.369945E−02 | 5.055969E−02 | −7.097052E−02 | 2.145318E−02 |
| A12 | −8.501439E−05 | −8.218982E−04 | −2.673181E−02 | 5.609591E−02 | 5.852544 E−02 | −1.022666E−02 |
| A14 | 0.000000E+00 | 0.000000E+00 | 6.919298E−03 | −8.696561E−02 | −3.042678E−02 | −8.336471E−05 |
| A16 | 0.000000E+00 | 0.000000E+00 | −6.473858E−04 | 3.364976E−02 | 2.808052E−03 | −3.878583E−04 |
| A18 | 0.000000E+00 | 0.000000E+00 | 0.000000E+00 | 0.000000E+00 | 0.000000E+00 | 0.000000E+00 |
| A20 | 0.000000E+00 | 0.000000E+00 | 0.000000E+00 | 0.000000E+00 | 0.000000E+00 | 0.000000E+00 |

| | Eighth Surface | Ninth Surface | Tenth Surface | Eleventh Surface |
|---|---|---|---|---|
| k | 0.000000E+00 | 0.000000E+00 | 0.000000E+00 | 0.000000E+00 |
| A4 | 3.565980E−03 | 4.816465E−02 | −2.174569E−02 | −5.218376E−02 |
| A6 | −7.798661E−02 | −1.239807E−01 | −1.799482E−02 | 1.018580E−02 |
| A8 | 4.444888E−02 | 7.930115E−02 | −8.020747E−03 | −4.715860E−03 |
| A10 | −1.639119E−04 | −2.516064E−02 | 2.375735E−02 | 3.038311E−03 |
| A12 | −1.373830E−03 | 4.133857E−03 | −1.381903E−02 | −9.350047E−04 |
| A14 | −1.972488E−03 | −4.554366E−04 | 3.382125E−03 | 7.865601E−05 |
| A16 | 6.832546E−04 | 4.005185E−05 | −3.033591E−04 | 7.838024E−06 |
| A18 | 0.000000E+00 | 0.000000E+00 | 0.000000E+00 | 0.000000E+00 |
| A20 | 0.000000E+00 | 0.000000E+00 | 0.000000E+00 | 0.000000E+00 |

The imaging lens in Example 1 satisfies conditional expressions (1) to (16) as shown in Table 5.

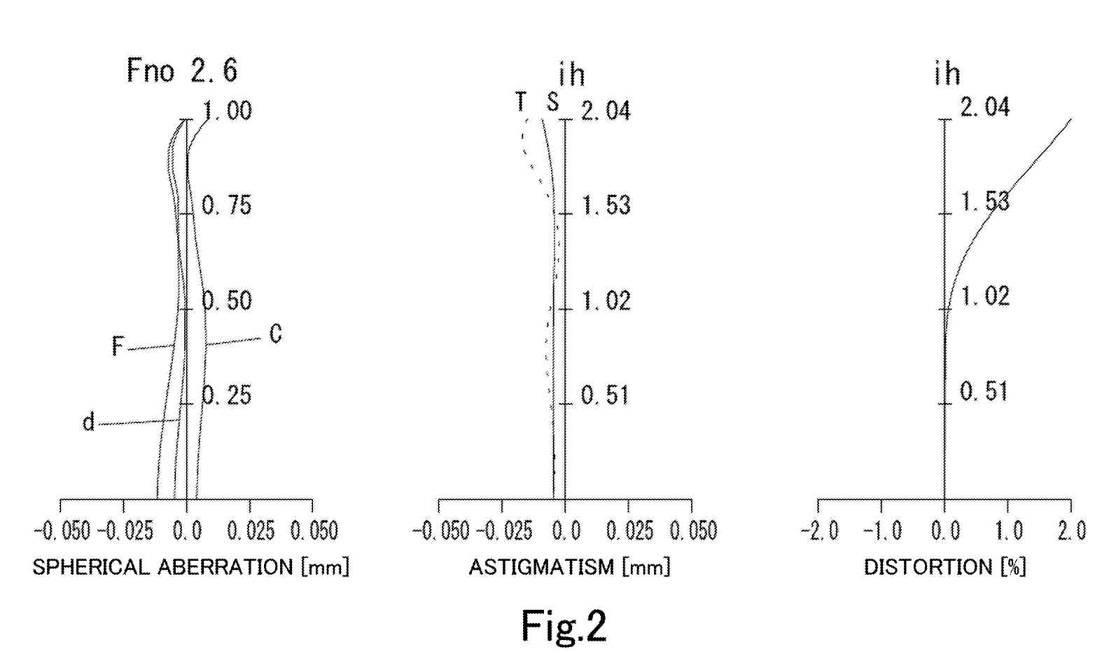

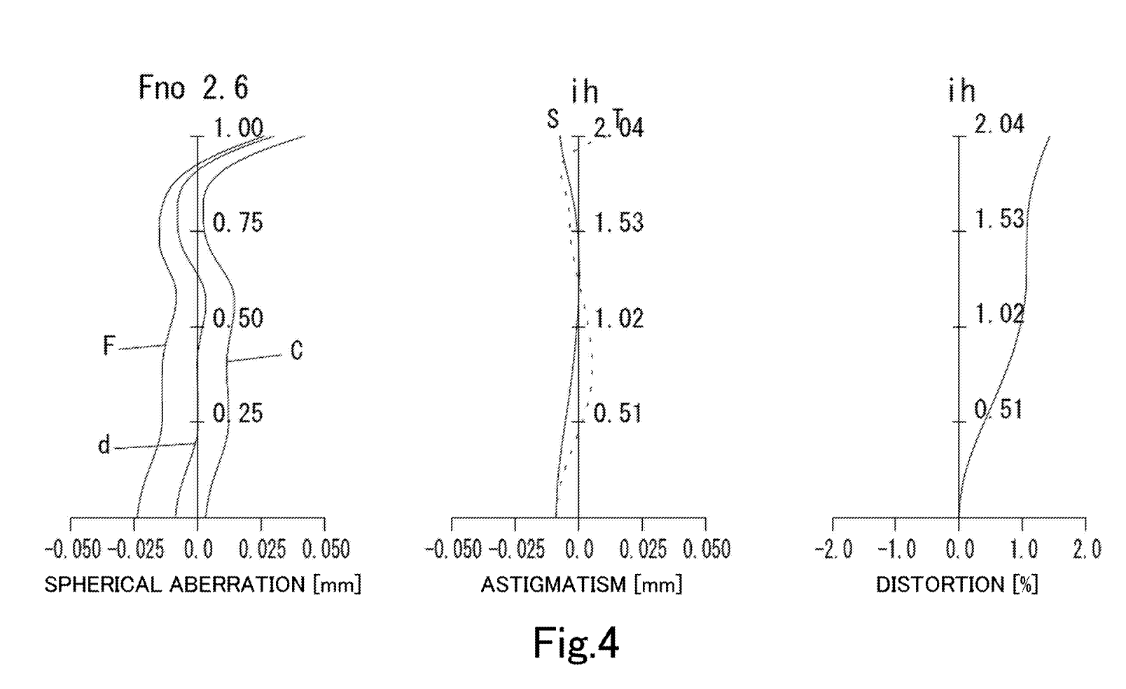

FIG. 2 shows spherical aberration (mm), astigmatism (mm), and distortion (%) of the imaging lens in Example 1. The spherical aberration diagram shows the amount of aberration at wavelengths of F-ray (486 nm), d-ray (588 nm), and C-ray (656 nm). The astigmatism diagram shows the amount of aberration at d-ray on a sagittal image surface S (solid line) and on tangential image surface T (broken line), respectively (same as FIGS. 4, 6 and 8). As shown in FIG. 2, each aberration is corrected excellently.

### EXAMPLE 2

The basic lens data is shown below in Table 2.

TABLE 2
Example 2
Unit mm

| | |
|---|---|
| f = 7.46 | ih = 2.04 |
| Fno = 2.6 | TTL = 6.36 |
| ω (°) = 15.1 | |

Surface Data

| Surface | Curvature | Surface | Refractive | Abbe |
|---|---|---|---|---|
| Number i | Radius r | Distance d | Index Nd | Number vd |
| (Object) | Infinity | Infinity | | |
| 1 (Stop) | Infinity | −0.6876 | | |
| 2* | 1.7434 | 0.9573 | 1.544 | 55.86 (vd1) |
| 3* | 23.0516 | 0.2910 | | |
| 4* | 12.1435 | 0.2300 | 1.661 | 20.37 (vd2) |
| 5* | 3.1800 | 1.3168 | | |
| 6* | 119.2091 | 0.2400 | 1.661 | 20.37 (vd3) |
| 7* | 8.3489 | 1.0063 | | |
| 8* | −3.0285 | 0.3200 | 1.544 | 55.86 (vd4) |
| 9* | 14.1442 | 0.1307 | | |
| 10* | −48.0346 | 0.9080 | 1.661 | 20.37 (vd5) |
| 11* | −3.7838 | 0.2000 | | |
| 12 | Infinity | 0.1100 | 1.517 | 64.17 |
| 13 | Infinity | 0.6872 | | |
| Image Plane | Infinity | | | |

Constituent Lens Data

| Lens | Start Surface | Focal Length | Composite | Focal Length | entrance | pupil radius |
|---|---|---|---|---|---|---|
| 1 | 2 | 3.411 | f45 | −38.766 | EPsd | 1.435 |
| 2 | 4 | −6.587 | | | | |
| 3 | 6 | −13.599 | | | | |
| 4 | 8 | −4.553 | | | | |
| 5 | 10 | 6.166 | | | | |

Aspheric Surface Data

| | Second Surface | Third Surface | Fourth Surface | Fifth Surface | Sixth Surface | Seventh Surface |
|---|---|---|---|---|---|---|
| k | 2.932971E−03 | 1.680885E+00 | −4.755817E−01 | 1.039042E−01 | 7.000000E+01 | 1.781251E−01 |
| A4 | −2.660611E−03 | 1.053507E−02 | −9.223694E−03 | −3.887980E−03 | −8.004207E−02 | −4.134463E−02 |
| A6 | 9.824596E−03 | 1.443704E−02 | 7.359654E−02 | 1.086777E−01 | 1.152971E−01 | 1.048366E−01 |
| A8 | −1.829568E−02 | −2.365689E−02 | −1.507056E−01 | −2.175317E−01 | −4.254652E−02 | 3.434343E−02 |
| A10 | 2.036061E−02 | 1.905059E−02 | 2.014476E−01 | 3.315009E−01 | −8.232374E−02 | −1.787816E−01 |
| A12 | −1.247703E−02 | −6.455118E−03 | −1.498775E−01 | −2.378739E−01 | 1.568176E−01 | 2.274534E−01 |
| A14 | 3.979774E−03 | 6.660092E−04 | 5.766025E−02 | 6.951977E−02 | −1.048028E−01 | −1.289384E−01 |
| A16 | −4.729278E−04 | 0.000000E+00 | −9.626900E−03 | 0.000000E+00 | 2.229191E−02 | 2.576102E−02 |
| A18 | 0.000000E+00 | 0.000000E+00 | 0.000000E+00 | 0.000000E+00 | 0.000000E+00 | 0.000000E+00 |
| A20 | 0.000000E+00 | 0.000000E+00 | 0.000000E+00 | 0.000000E+00 | 0.000000E+00 | 0.000000E+00 |

| | Eighth Surface | Ninth Surface | Tenth Surface | Eleventh Surface |
|---|---|---|---|---|
| k | 0.000000E+00 | −9.093398E+00 | 0.000000E+00 | −1.608115E−02 |
| A4 | −7.409997E−02 | 4.398636E−02 | 1.006408E−01 | 1.673690E−02 |
| A6 | 4.890959E−02 | −1.568115E−01 | −1.702616E−01 | −2.466397E−02 |
| A8 | 2.955994E−02 | 1.667638E−01 | 1.214458E−01 | 4.972759E−03 |
| A10 | −4.599931E−02 | −1.005506E−01 | −5.398216E−02 | 3.637953E−03 |
| A12 | 1.978011E−02 | 3.559311E−02 | 1.274349E−02 | −5.505583E−03 |
| A14 | −2.550709E−03 | −6.935706E−03 | 2.102813E−04 | 3.409133E−03 |
| A16 | −2.832005E−04 | 5.684739E−04 | −9.680597E−04 | −1.136295E−03 |
| A18 | 6.744323E−05 | −1.175501E−07 | 2.278898E−04 | 1.977473E−04 |
| A20 | 0.000000E+00 | 0.000000E+00 | −1.775619E−05 | −1.389227E−05 |

The imaging lens in Example 2 satisfies conditional expressions (1) to (16) as shown in Table 5.

FIG. 4 shows spherical aberration (mm), astigmatism (mm), and distortion (%) of the imaging lens in Example 2. As shown in FIG. 4, each aberration is corrected excellently.

### EXAMPLE 3

The basic lens data is shown below in Table 3.

TABLE 3
Example 3
Unit mm

| | |
|---|---|
| f = 7.48 | ih = 2.04 |
| Fno = 2.4 | TTL = 6.35 |
| ω (°) = 15.0 | |

Surface Data

| Surface | Curvature | Surface | Refractive | Abbe |
|---|---|---|---|---|
| Number i | Radius r | Distance d | Index Nd | Number vd |
| (Object) | Infinity | Infinity | | |
| 1 (Stop) | Infinity | −0.7142 | | |
| 2* | 1.8075 | 1.0623 | 1.544 | 55.86 (vd1) |
| 3* | 48.1456 | 0.2507 | | |
| 4* | 11.3052 | 0.2300 | 1.661 | 20.37 (vd2) |
| 5* | 3.0538 | 1.3447 | | |
| 6* | 9.9207 | 0.2350 | 1.661 | 20.37 (vd3) |
| 7* | 4.8439 | 1.1262 | | |
| 8* | −2.9134 | 0.3200 | 1.544 | 55.86 (vd4) |
| 9* | 14.8044 | 0.0432 | | |
| 10* | −12.6395 | 0.8679 | 1.661 | 20.37 (vd5) |
| 11* | −3.1824 | 0.2000 | | |
| 12 | Infinity | 0.1100 | 1.517 | 64.17 |
| 13 | Infinity | 0.6021 | | |
| Image Plane | Infinity | | | |

Constituent Lens Data

| Lens | Start Surface | Focal Length | Composite | Focal Length | entrance | pupil radius |
|---|---|---|---|---|---|---|
| 1 | 2 | 3.423 | f45 | −31.460 | EPsd | 1.559 |
| 2 | 4 | −6.403 | | | | |
| 3 | 6 | −14.594 | | | | |
| 4 | 8 | −4.444 | | | | |
| 5 | 10 | 6.210 | | | | |

Aspheric Surface Data

| | Second Surface | Third Surface | Fourth Surface | Fifth Surface | Sixth Surface | Seventh Surface |
|---|---|---|---|---|---|---|
| k | −2.209186E−02 | −9.000000E+01 | 2.966712E+01 | 4.994215E−01 | 6.574665E+01 | 1.220000E+01 |
| A4 | −1.176597E−02 | −2.509336E−03 | −5.142116E−02 | −5.786353E−02 | −3.405834E−02 | −3.014619E−02 |
| A6 | 5.803553E−02 | 9.329749E−02 | 4.384175E−01 | 7.489515E−01 | 2.327721E−01 | 3.747324E−01 |
| A8 | −1.642890E−01 | −3.108919E−01 | −1.577144E+00 | −3.540900E+00 | −8.877228E−01 | −1.419837E+00 |
| A10 | 2.762015E−01 | 5.765029E−01 | 3.452123E+00 | 1.078271E+01 | 2.528002E+00 | 3.802329E+00 |
| A12 | −2.918697E−01 | −6.539297E−01 | −4.782861E+00 | −2.109855E+01 | −4.622868E+00 | −6.382699E+00 |
| A14 | 1.953384E−01 | 4.636657E−01 | 4.254888E+00 | 2.659313E+01 | 5.392477E+00 | 6.797739E+00 |
| A16 | −8.034697E−02 | −2.009426E−01 | −2.367658E+00 | −2.078413E+01 | −3.902802E+00 | −4.470129E+00 |
| A18 | 1.852982E−02 | 4.857764E−02 | 7.507544E−01 | 9.132673E+00 | 1.591991E+00 | 1.649417E+00 |
| A20 | −1.839870E−03 | −5.015433E−03 | −1.034984E−01 | −1.719510E+00 | −2.798909E−01 | −2.617171E−01 |

| | Eighth Surface | Ninth Surface | Tenth Surface | Eleventh Surface |
|---|---|---|---|---|
| k | 0.000000E+00 | 3.562278E+00 | 0.000000E+00 | −1.135929E+00 |
| A4 | −1.268988E−01 | −2.980986E−02 | 8.946511E−02 | 1.530826E−02 |
| A6 | 8.040041E−02 | 8.377405E−03 | −1.216405E−01 | −4.988875E−02 |
| A8 | 9.677668E−03 | −3.599420E−02 | 1.111235E−01 | 6.953747E−02 |
| A10 | −3.764881E−02 | 3.109483E−02 | −1.197571E−01 | −6.504513E−02 |
| A12 | 2.046058E−02 | −1.063373E−02 | 9.473073E−02 | 3.580592E−02 |
| A14 | −4.212611E−03 | 1.262898E−03 | −4.453644E−02 | −1.180824E−02 |
| A16 | 2.678643E−04 | 0.000000E+00 | 1.190124E−02 | 2.290614E−03 |
| A18 | 0.000000E+00 | 0.000000E+00 | −1.671914E−03 | −2.365262E−04 |
| A20 | 0.000000E+00 | 0.000000E+00 | 9.578437E−05 | 9.774815E−06 |

The imaging lens in Example 3 satisfies conditional expressions (1) to (16) as shown in Table 5.

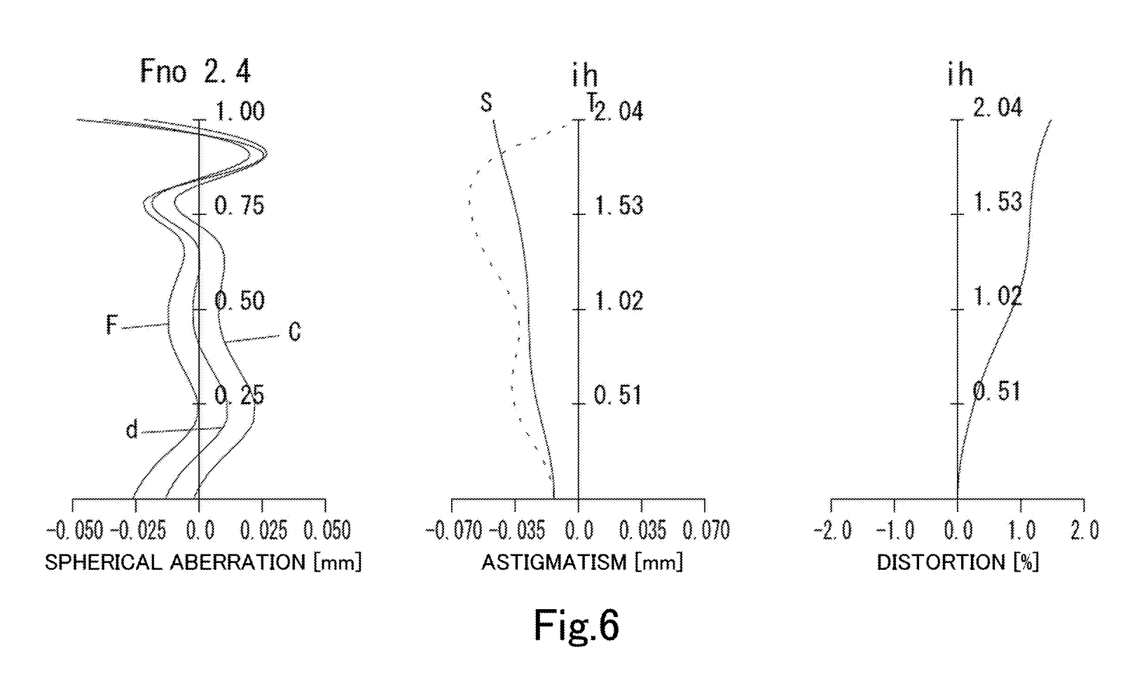

FIG. 6 shows spherical aberration (mm), astigmatism (mm), and distortion (%) of the imaging lens in Example 3. As shown in FIG. 6, each aberration is corrected excellently.

### EXAMPLE 4

The basic lens data is shown below in Table 4.

TABLE 4
Example 4
Unit mm

| | |
|---|---|
| f = 7.48 | ih = 2.04 |
| Fno = 2.4 | TTL = 6.36 |
| ω (°) = 15.0 | |

Surface Data

| Surface | Curvature | Surface | Refractive | Abbe |
|---|---|---|---|---|
| Number i | Radius r | Distance d | Index Nd | Number vd |
| (Object) | Infinity | Infinity | | |
| 1 (Stop) | Infinity | −0.7095 | | |
| 2* | 1.8058 | 1.0444 | 1.544 | 55.86 (vd1) |
| 3* | 43.9243 | 0.3351 | | |
| 4* | 22.8360 | 0.2300 | 1.661 | 20.37 (vd2) |
| 5* | 3.4387 | 1.1947 | | |
| 6* | 16.2436 | 0.2400 | 1.561 | 20.37 (vd3) |
| 7* | 6.9212 | 1.2034 | | |
| 8* | −2.9133 | 0.3200 | 1.544 | 55.86 (vd4) |
| 9* | 18.9026 | 0.0447 | | |
| 10* | −10.7138 | 0.8877 | 1.661 | 20.37 (vd5) |
| 11* | −3.2988 | 0.2000 | | |
| 12 | Infinity | 0.1100 | 1.517 | 64.17 |
| 13 | Infinity | 0.5844 | | |
| Image Plane | Infinity | | | |

Constituent Lens Data

| Lens | Start Surface | Focal Length | Composite | Focal Length | entrance | pupil radius |
|---|---|---|---|---|---|---|
| 1 | 2 | 3.430 | f45 | −24.223 | EPsd | 1.559 |
| 2 | 4 | −6.156 | | | | |
| 3 | 6 | −18.440 | | | | |
| 4 | 8 | −4.614 | | | | |
| 5 | 10 | 6.886 | | | | |

Aspheric Surface Data

| | Second Surface | Third Surface | Fourth Surface | Fifth Surface | Sixth Surface | Seventh Surface |
|---|---|---|---|---|---|---|
| k | 0.000000E+00 | 0.000000E+00 | 0.000000E+00 | 0.000000E+00 | 0.000000E+00 | 0.000000E+00 |
| A4 | −1.527880E−02 | −2.214803E−02 | −4.230906E−02 | −2.104479E−02 | 1.023010E−02 | 2.615056E−02 |
| A6 | 5.851894E−02 | 1.152875E−01 | 3.141427E−01 | 3.986938E−01 | 9.367261E−02 | 1.663843E−01 |
| A8 | −1.577934E−01 | −2.718175E−01 | −6.562830E−01 | −1.009812E+00 | −1.497384E−01 | −4.639649E−01 |
| A10 | 2.586734E−01 | 4.199299E−01 | 6.653729E−01 | 1.580441E+00 | 3.127555E−01 | 1.215624E+00 |
| A12 | −2.686616E−01 | −4.293036E−01 | −5.542758E−02 | −1.412280E+00 | −5.182480E−01 | −2.004733E+00 |
| A14 | 1.767722E−01 | 2.847216E−01 | −6.164081E−01 | 6.759646E−01 | 4.589948E−01 | 1.871518E+00 |
| A16 | −7.143777E−02 | −1.177237E−01 | 6.601928E−01 | −1.383263E−01 | −1.437903E−01 | −8.669435E−01 |
| A18 | 1.617474E−02 | 2.747673E−02 | −2.930625E−01 | 5.293922E−03 | −3.661275E−02 | 1.283520E−01 |
| A20 | −1.577192E−03 | −2.761847E−03 | 4.974590E−02 | 0.000000E+00 | 1.891703E−02 | 1.488861E−02 |

| | Eighth Surface | Ninth Surface | Tenth Surface | Eleventh Surface |
|---|---|---|---|---|
| k | 0.000000E+00 | 0.000000E+00 | 0.000000E+00 | 0.000000E+00 |
| A4 | −8.175004E−02 | 1.464777E−01 | 1.928365E−01 | 3.510265E−03 |
| A6 | −1.673522E−01 | −5.765429E−01 | −4.156444E−01 | −2.931774E−02 |
| A8 | 4.735081E−01 | 7.743148E−01 | 4.689278E−01 | 8.270351E−02 |
| A10 | −4.819761E−01 | −5.446034E−01 | −2.999665E−01 | −1.025530E−01 |
| A12 | 2.327780E−01 | 2.085370E−01 | 1.037416E−01 | 6.878479E−02 |
| A14 | −5.221906E−02 | −4.128727E−02 | −1.505085E−02 | −2.739618E−02 |
| A16 | 4.337992E−03 | 3.311619E−03 | −1.017061E−03 | 6.529791E−03 |
| A18 | 0.000000E+00 | 0.000000E+00 | 5.752996E−04 | −8.610200E−04 |
| A20 | 0.000000E+00 | 0.000000E+00 | −4.937757E−05 | 4.821043E−05 |

The imaging lens in Example 4 satisfies conditional expressions (1) to (16) as shown in Table 5.

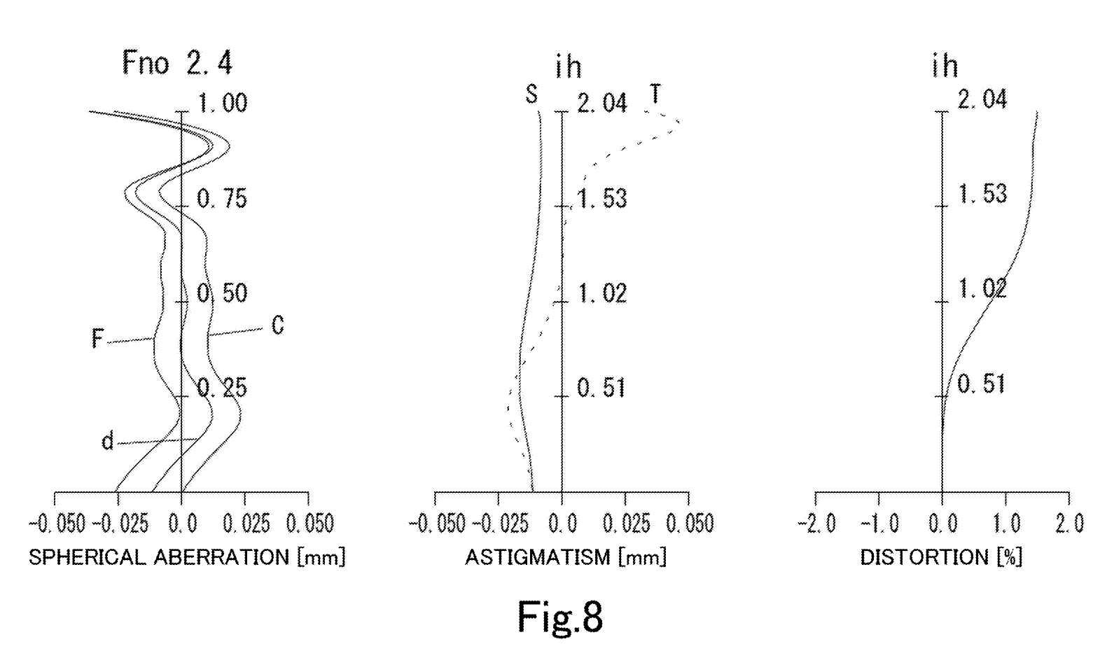

FIG. 8 shows spherical aberration (mm), astigmatism (mm), and distortion (%) of the imaging lens in Example 4. As shown in FIG. 8, each aberration is corrected excellently.

In table 5, values of conditional expressions (1) to (16) related to the Examples 1 to 4 are shown.

TABLE 5

| | | Exam- | Exam- | Exam- | Exam- |
|---|---|---|---|---|---|
| Conditional Expression | | ple 1 | ple 2 | ple 3 | ple 4 |
| (1) | TTL/f | 0.86 | 0.85 | 0.85 | 0.85 |
| (2) | f5/TTL | 1.10 | 0.97 | 0.98 | 1.08 |
| (3) | f1/f | 0.45 | 0.46 | 0.46 | 0.46 |
| (4) | f2/f | −0.88 | −0.88 | −0.86 | −0.82 |
| (5) | f4/f | −0.64 | −0.61 | −0.59 | −0.62 |
| (6) | vd1/(vd2 + vd3) | 1.37 | 1.37 | 1.37 | 1.37 |
| (7) | vd4/vd5 | 2.74 | 2.74 | 2.74 | 2.74 |
| (8) | D1/ΣD | 0.37 | 0.36 | 0.39 | 0.38 |
| (9) | r7/r8 | −0.28 | −0.21 | −0.20 | −0.15 |
| (10) | \|r9\|/r10 | −3.67 | −12.69 | −3.97 | −3.25 |
| (11) | T2/TTL | 0.22 | 0.21 | 0.21 | 0.19 |
| (12) | T2/T3 | 1.59 | 1.31 | 1.19 | 0.99 |
| (13) | (EPsd × TTL)/(ih × f) | 0.60 | 0.60 | 0.65 | 0.65 |
| (14) | f3/f | −1.57 | −1.82 | −1.95 | −2.46 |
| (15) | f45/f | −2.75 | −5.19 | −4.21 | −3.24 |
| (16) | Σ(L1F−L5R)/f | 0.70 | 0.72 | 0.73 | 0.73 |

When the imaging lens according to the present invention is adopted to a product with the camera function, there is realized contribution to the wide field of view, the low-profileness and the low F-number of the camera and also high performance thereof.

### DESCRIPTION OF REFERENCE NUMERALS

ST: aperture stop,

L1: first lens,

L2: second lens,

L3: third lens,

L4: fourth lens,

L5: fifth lens,

L6: sixth lens,

ih: maximum image height,

IR: filter, and

IMG: image plane.

1. An imaging lens comprising in order from an object side to an image side,
a first lens,
a second lens having a convex surface facing the object side near an optical axis,
a third lens having negative refractive power and the convex surface facing the object side near the optical axis,
a fourth lens, and
a fifth lens, wherein below conditional expressions (1) and (2) are satisfied:
0.4<TTL/f<1.0 (1)
0.4<f5/TTL<1.7 (2)
where
TTL: total track length,
f: focal length of an overall optical system, and
f5: focal length of the fifth lens.

2. An imaging lens comprising in order from an object side to an image side,
a first lens,
a second lens having the convex surface facing the object side near the optical axis,
a third lens having the negative refractive power and the convex surface facing the object side near the optical axis,
a fourth lens, and
a fifth lens, wherein said second lens has a meniscus shape near the optical axis, and a conditional expression (2) is satisfied:
0.4<f5/TTL<1.7 (2)
where
f5: focal length of the fifth lens, and
TTL: total track length.

3. The imaging lens according to claim, wherein a below conditional expression (3) is satisfied:
0.2<f1/f<0.7 (3)
where
f1: focal length of the first lens, and
f: focal length of an overall optical system.

4. The imaging lens according to claim 1, wherein a below conditional expression (4) is satisfied:
−1.35<f2/f<−0.40 (4)
where
f2: focal length of the second lens, and
f: focal length of an overall optical system.

5. The imaging lens according to claim 1, wherein a below conditional expression (5) is satisfied:
−1.0<f4/f<−0.3 (5)
where
f4: focal length of the fourth lens, and
f: focal length of an overall optical system.

6. The imaging lens according to claim 1, wherein a below conditional expression (6) is satisfied:
0.65<vd1/(vd2+vd3)<2.10 (6)
where
vd1: abbe number at d-ray of the first lens,
vd2: abbe number at d-ray of the second lens, and
vd3: abbe number at d-ray of the third lens L3.

7. The imaging lens according to claim 1, wherein a below conditional expression (7) is satisfied:
1.35<vd4/vd5<4.15 (7)
where
vd4: abbe number at d-ray of the fourth lens, and
vd5: abbe number at d-ray of the fifth lens.

8. The imaging lens according to claim 1, wherein a below conditional expression (8) is satisfied:
0.15<D1/ΣD<0.60 (8)
where
D1: thickness along the optical axis of the first lens, and
ΣD: total sum of the thickness along the optical axis of the first lens, the second lens, the third lens, the fourth lens and the fifth lens.

9. The imaging lens according to claim 1, wherein an image-side surface of said fifth lens is the convex surface facing the image side near the optical axis.

10. The imaging lens according to claim 1, wherein a below conditional expression (9) is satisfied:
−0.40<r7/r8<−0.05 (9)
where
r7: paraxial curvature radius of an object-side surface of the fourth lens, and
r8: paraxial curvature radius of an image-side surface of the fourth lens.

11. The imaging lens according to claim 1, wherein a below conditional expression (10) is satisfied:
−19.0<|r9|/r10<−1.6 (10)
where
r9: paraxial curvature radius of an object-side surface of the fifth lens, and
r10: paraxial curvature radius of an image-side surface of the fifth lens.

12. The imaging lens according to claim 1, wherein a below conditional expression (11) is satisfied:
0.09<T2/TTL<0.35 (11)
where
T2: distance along the optical axis from the image-side surface of the second lens to an object- side surface of the third lens, and
TTL: total track length.

13. The imaging lens according to claim 1, wherein a below conditional expression (12) is satisfied:
0.5<T2/T3<2.4 (12)
where
T2: distance along the optical axis from an image-side surface of the second lens to an object- side surface of the third lens, and
T3: distance along the optical axis from an image-side surface of the third lens to an object-side surface of the fourth lens.

14. The imaging lens according to claim 1, wherein a below conditional expression (13) is satisfied:
0.3<(EPsd×TTL)/(ih×f)<1.0 (13)
where
EPsd: entrance pupil radius,
TTL: total track length,
ih: maximum image height, and
f: focal length of an overall optical system.

15. The imaging lens according to claim 2, wherein a below conditional expression (3) is satisfied:
0.2<f1/f<0.7 (3)
where
f1: focal length of the first lens, and
f: focal length of an overall optical system.

16. The imaging lens according to claim 2, wherein a below conditional expression (4) is satisfied:
−1.35<f2/f<−0.40 (4)
where
f2: focal length of the second lens, and
f: focal length of an overall optical system.

17. The imaging lens according to claim 2, wherein a below conditional expression (5) is satisfied:
−1.0<f4/f<−0.3 (5)
where
f4: focal length of the fourth lens, and
f: focal length of an overall optical system.

18. The imaging lens according to claim 2, wherein a below conditional expression (6) is satisfied:
0.65<vd1/(vd2+vd3)<2.10 (6)
where
vd1: abbe number at d-ray of the first lens,
vd2: abbe number at d-ray of the second lens, and
vd3: abbe number at d-ray of the third lens L3.

19. The imaging lens according to claim 2, wherein a below conditional expression (7) is satisfied:
1.35<vd4/vd5<4.15 (7)
where
vd4: abbe number at d-ray of the fourth lens, and
vd5: abbe number at d-ray of the fifth lens.

20. The imaging lens according to claim 2, wherein a below conditional expression (8) is satisfied:
0.15<D1/ΣD<0.60 (8)
where
D1: thickness along the optical axis of the first lens, and
ΣD: total sum of the thickness along the optical axis of the first lens, the second lens, the third lens, the fourth lens and the fifth lens.
